(19) United States
(12) Patent Application Publication
(10) Pub. No.: US 2006/0081825 A1
(43) Pub. Date: Apr. 20, 2006

(54) Motion transmission system for manoeuvring the ropes of sails in sailing boats

(75) Inventors: Alberto Lozza, Cornaredo (IT); Andrea Merello, Genova (IT)

Correspondence Address: PYLE & PIONTEK, 221 N. LASELLE STREET, SUITE 850, CHICAGO, IL, 60601, US

(73) Assignee: Harken Italy S.p.A.

(21) Appl. No.: 11/251,244

(22) Filed: Oct. 14, 2005

(30) Foreign Application Priority Data
Oct. 20, 2004 (IT) MI2004A001987

(51) Int. Cl. B66D 1/14

(52) U.S. Cl. 254/339

(57) ABSTRACT

The invention refers to a motion transmission system from at least one pedestal to at least one winch, for manoeuvring the ropes of sails in sailing boats, comprising speed multiplier means housed in said at least one pedestal. The present invention allows there to be a reduced torque value along the entire kinematic path from said at least one pedestal to said at least one winch. This allows lower quality and smaller sized (thickness) components to be used, with obvious advantages in terms of reduction of the costs and of the total weight on board the sailing boat.

The present invention relates to a motion transmission system for manoeuvring the ropes of sails in sailing boats.

In particular, the present invention refers to a motion transmission system for manoeuvring the ropes of sails in racing sailing boats, comprising at least one pedestal, at least one winch, kinematic connection means between said at least one pedestal and said at least one winch for the transmission of a rotary motion from said at least one pedestal to said at least one winch along at least one kinematic motion transmission path, and speed multiplier means active on said at least one kinematic motion transmission path to transfer the rotary motion from said at least one pedestal to said at least one winch with a first transmission ratio higher than 1:1.

The present invention also refers to a pedestal for sailing boats for such a motion transmission system.

The motion transmission system and the pedestal of the present invention find a preferred application, although not exclusive, in medium-large sized racing sailing boats, such as for example America's Cup yachts, and in general in all those sailing boats which compete in races wherein new wind conditions on the sails require new motion transmission configurations to be realized on board of the sailing boats, in the least possible time.

As known, motion transmission systems for manoeuvring the ropes of sails in medium-large sized sailing boats referred to in the present invention typically comprise a plurality of winches, a plurality of winch drive pedestals and kinematic connection means between the pedestals and the winches.

Winches are used on sailing boats to ease the manoeuvring and adjustment operations of the sails under strain, such as the positioning operations thereof. Such operations are carried out by manoeuvring suitable ropes or cables (also commonly indicated with the term sheets or halyards), suitably connected to the sails; the ropes, in particular, are pulled by winding them onto winches, which are suitably positioned on the deck of the boat.

The pedestals are generally positioned on the deck of the boat in a remote position with respect to the winches and are equipped with handles operated by the crew members of the boat.

The motion imparted by the crew on the pedestals is transferred to the winches along a kinematic motion transmission path defined by kinematic connection means between the pedestals and the winches.

The deck layout of such boats is designed so that the winches intended to work with particularly high loads, such as the primary winches in strong wind conditions, can be simultaneously operated by many members of the crew. In such a case, such winches are driven by many drive pedestals, typically two or three pedestals but theoretically also in a greater number, kinematically connected together so as to synchronise the motions driven by each of them.

Typically, the motion transmission from the pedestals to the winches takes place with a transmission ratio of 1:1, i.e. each turn of the handles on the pedestals corresponds to one turn of the input shaft (or main shaft) of the winches.

It has been noted the need to increase (typically double) such a transmission ratio so that each turn of the handles on the pedestals corresponds to more than one turn of the input shaft of the winches (typically two turns).

Such a requirement has been fulfilled in the prior art by inserting suitable cases provided with speed multiplier means into the kinematic motion transmission path between the pedestals and the winches suitable for being selectively activated when desired.

An example of such speed multiplier cases is described in patent application no. IT2001MI0595 of the same Applicant.

The Applicant has now found a new solution suitable for satisfying the requirement of increasing the transmission ratio between pedestals and winches so that each turn of the handles on the pedestals corresponds to more than one turn of the input shaft of the winches.

The invention therefore concerns, in a first aspect thereof, a motion transmission system for manoeuvring the ropes of sails in sailing boats, comprising at least one pedestal, at least one winch, kinematic connection means between said at least one pedestal and said at least one winch for the transmission of a rotary motion from said at least one pedestal to said at least one winch along at least one kinematic motion transmission path, and speed multiplier means active on said at least one kinematic motion transmission path to transfer the rotary motion from said at least one pedestal to said at least one winch with a first transmission ratio higher than 1:1, characterised in that said speed multiplier means are housed in said at least one pedestal.

Advantageously, the present invention allows the desired increase in transmission ratio between pedestal and winch to be achieved generating a lower torque value with respect to the prior art solution along the entire motion transmission system between the pedestals and the winches. Said torque value reduction allows lower quality and smaller sized (thickness) components to be used, with obvious advantages in terms of cost and overall weight reduction on the boat board.

Preferably, such a pedestal comprises a drive pulley housed at a top end thereof, a driven pulley housed at a bottom end thereof and associated in output with said kinematic connection means, and a motion transmission belt between said drive pulley and said driven pulley, wherein said driven pulley has a diameter lower than the diameter of said drive pulley and wherein said speed multiplier means consist of said driven pulley. It is thus possible to obtain the desired increase of the motion transmission ratio in output from the pedestal (and, advantageously, the desired reduction in the torque value generated along the entire motion transmission system between pedestal and winch) by reducing the diameter of the driven pulley with respect to the pedestals of the prior art. With respect to the solution of the prior art discussed above, therefore, the motion transmission system of the present invention, as well as not foreseeing the use of special multiplication cases along the kinematic path between pedestal and winch, foresees the use of a driven pulley of smaller diameter: all of this allows the overall weight of the boat to be kept low.

Preferably, the diameter of said driven pulley is about half the diameter of said drive pulley, consequently obtaining a motion transmission ratio of about 2:1 (i.e. one turn of the handles in the pedestals corresponds to two turns of the input shaft of the winch).

In a particularly preferred embodiment of the motion transmission system of the present invention, the kinematic connection means between said at least one pedestal and said at least one winch comprise speed reducing means able to be selectively activated on said at least one kinematic motion transmission path to transfer the rotary motion from said at least one pedestal to said at least one winch with a second transmission ratio lower then said first transmission ratio, said speed reducing means being housed in a case (hereafter also indicated as speed reducing case) positioned at the input of said at least one winch.

Preferably, said second transmission ratio is 1:1.

Advantageously, the activation of the speed reducing means allows, when desired, to cancel the multiplication speed obtained inside the pedestal so as to reset a transmission ratio of 1:1 at the input of the winch. Even more advantageously, the positioning of the case containing the speed reducing means immediately upstream of the winch allows the rotary motion to be transmitted to the winch with a transmission ratio of 1:1, at the same time maintaining a low torque value in the entire transmission system upstream of such a case, thus achieving all of the advantages discussed above.

Preferably, when said speed reducing means are deactivated, the motion transmission from said at least one pedestal to said at least one winch takes place with said first transmission ratio (for example 2:1), while when said speed reducing means are activated, the motion transmission from said at least one pedestal to said at least one winch takes place with said second transmission ratio (for example 1:1).

Even more preferably, said speed reducing means comprise an input shaft rotating at an input speed and intended to be associated with said kinematic connection means between said at least one pedestal and said at least one winch, an output shaft rotating at an output speed and intended to be associated with said at least one winch, a first kinematic path for the motion transmission from said input shaft to said output shaft with said first transmission ratio, a second kinematic path for the motion transmission from said input shaft to said output shaft with said second transmission ratio, and means for selectively activating said first and second kinematic paths.

An example of a case suitable for making a speed reduction is described in the patent application no. IT2001MI0595 of the same Applicant.

Advantageously, the presence along the entire motion transmission system of a low torque value makes it possible to use smaller sized speed reduction cases and/or transfer cases with respect to those used in the solution of the prior art discussed above; it is thus possible to achieve all of the advantages discussed above without making a significant weight increase of the boat (also in the case in which it is necessary to foresee a number of speed reduction cases and/or of transfer cases larger than the solution of the prior art discussed above).

In a second aspect thereof, the present invention concerns a pedestal for the motion transmission to at least one winch for manoeuvring the ropes in sailing boats, characterised in that it comprises speed multiplier means to transfer a rotary motion to at least one winch with a first transmission ratio higher than 1:1.

Preferably, such a pedestal comprises a drive pulley housed at a top end thereof, a driven pulley housed at a bottom end thereof and intended to be associated in output with kinematic connection means between said pedestal and said at least one winch, and a motion transmission belt between said drive pulley and said driven pulley, wherein said driven pulley has a diameter lower than the diameter of said drive pulley and wherein said speed multiplier means consist of said driven pulley.

More preferably, the diameter of said driven pulley is about half the diameter of said drive pulley.

Such a pedestal allows a motion transmission system to be obtained having all of the advantageous characteristics highlighted above.

Further characteristics and advantages of the present invention shall become clearer from the following detailed description of a preferred embodiment thereof, made with reference to the attached drawings. In such drawings,

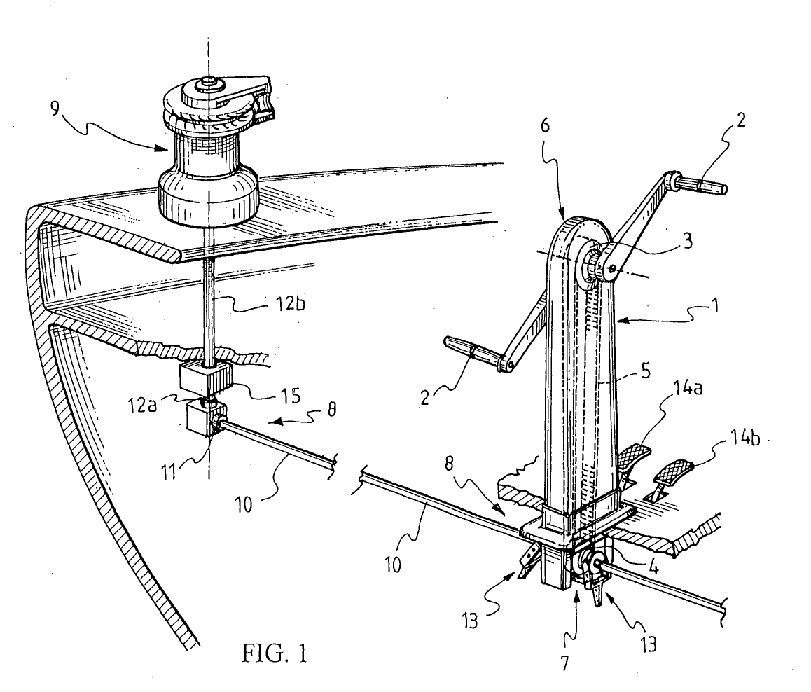

FIG. 1 represents a schematic perspective view of a cross section of a portion of the deck of a sailing boat provided with a motion transmission system in accordance with the present invention;

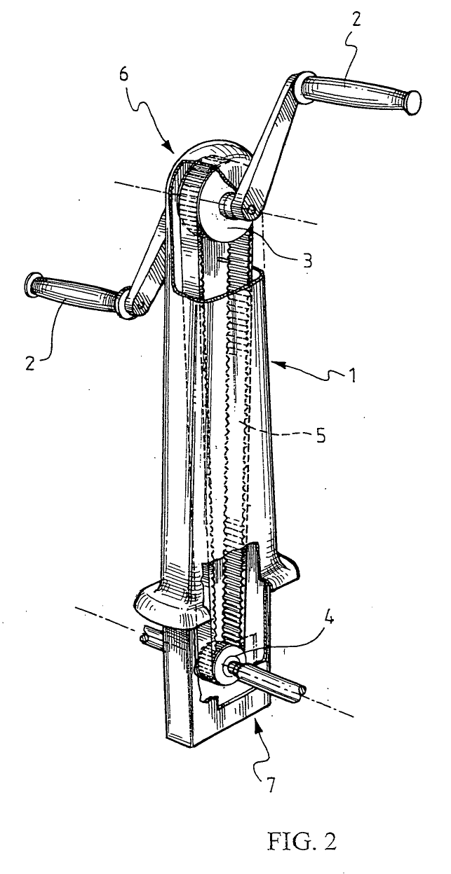

FIG. 2 represents a schematic perspective view of a pedestal in accordance with the present invention;

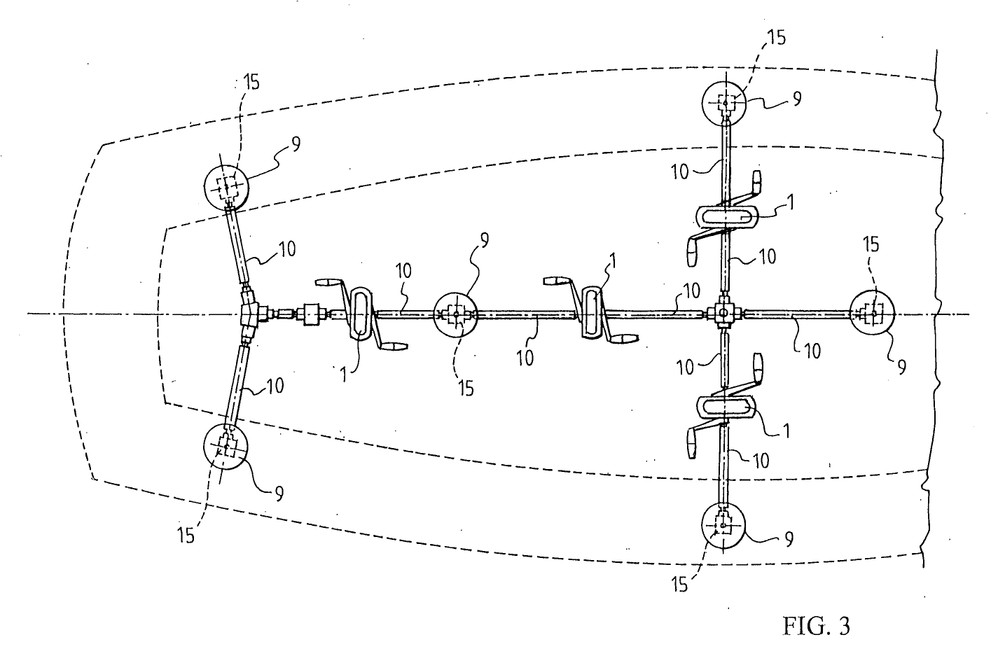

FIG. 3 represents a schematic view of a layout of a sailing boat having the motion transmission system of FIG. 1.

In FIG. 1 a preferred embodiment of the transmission system according to the present invention is shown. Such a transmission system comprises, amongst other things, conventional components generally present on a medium-large size sailing boat, such as, for example, a pedestal 1 (provided with suitable actuation handles 2), a winch 9, and kinematic connection means, wholly indicated with 8, between the pedestal 1 and the winch 9 for the transmission of a rotary motion from the pedestal 1 to the winch 9 along a kinematic motion transmission path. The kinematic connection means 8 comprise, in particular, a motion transmission shaft 10 positioned under the deck of the boat in output from the pedestal 1 and a 90° transfer case 11, positioned below the winch 9 and suitable for transferring to the winch 9 the rotary motion imparted by the crew members to the handles 2 of the pedestal 1 and transmitted through the shaft 10. The kinematic connection means 8 also comprise other conventional components, such as the engage/disengage mechanism 13 activated by the crew members through a button/pedal 14a foreseen at the base of the pedestal 1, such an engage/disengage mechanism 13 being suitable for activating/deactivating the kinematic connection between the pedestal 1 and the winch 9.

As shown in FIGS. 1 and 2, the pedestal 1 comprises a drive pulley 3, housed at a top end 6 thereof, a driven pulley 4, housed at a bottom end 7 thereof an associated in output with the kinematic connection means 8, and a motion transmission belt 5 between the drive pulley 3 and the driven pulley 4. In accordance with the present invention, the driven pulley 4 has a diameter lower (about half) than the diameter of the drive pulley 3, in such a way making a speed increase (and therefore a transmission ratio higher than 1:1) at the output of the pedestal 1.

In accordance with the preferred embodiment of the transmission system of the present invention, shown in FIG. 1, the kinematic connection means 8 between the pedestal 1 and the winch 9 also comprise, between the pedestal 1 and the winch 9, a case 15 provided with speed reducing means to transfer the rotary motion from the pedestal 1 to the winch 9 with a second transmission ratio lower than the aforementioned first transmission ratio. Such a case 15 is positioned at the input of the winch 9, in particular between the winch 9 and the 90° transfer case 11. Such a second transmission ratio is, preferably, 1:1.

The case 15 is provided with conventional speed reducing means (see for example patent application no. IT2001MI0595 of the same Applicant, where a case suitable for carrying out both a multiplication and a reduction of speed is described) and therefore is not described in detail in this context. The speed reducing means comprise, in particular, an input shaft 12a rotating at an input speed and associated with the kinematic connection means 8, an output shaft 12b rotating at an output speed and associated with the winch 9 (constituting, for example, the input shaft of the winch 9), a first kinematic path (not shown) for the motion transmission from the input shaft 12a to the output shaft 12b having the aforementioned first transmission ratio and a second kinematic path (not shown) for the motion transmission from the input shaft 12a to the output shaft 12b having the aforementioned second transmission ratio. Per se conventional and not illustrated means for selectively activating the aforementioned first and second kinematic paths are also foreseen. Such means comprise, for example, an active mechanical or pneumatic circuit, through a suitable actuation pedal/button 14b foreseen at the base of the pedestal 1, on a engage/disengage mechanism foreseen in the case 15 and suitable for selectively activating/deactivating the aforementioned first and second kinematic paths.

In FIG. 3 a preferred embodiment of a layout of a boat having the transmission system according to the present invention is shown, comprising a plurality of winches 9, actuated by a plurality of pedestals 1. In such a FIG. 3 a plurality of motion transmission shafts 10 from the pedestals 1 to the winches 9 and a plurality of cases 15 provided with speed reducing means, each of them is positioned below a respective winch 9, are also shown.

In operation, the motion transmission system of the present invention allows a rotary motion to be transmitted from at least one pedestal 1 to at least one winch 9. In a first operative configuration, the rotary motion is transmitted along a kinematic motion transmission path with a first transmission ratio higher than 1:1, i.e. one turn of the handles 2 of the pedestal 1 corresponds to many turns of the input shaft of the winch 9. Such speed multiplication (and therefore the increase in transmission ratio) takes place inside the pedestal 1 and is kept unaltered up to the winch 9. In such an operative configuration the speed reducing means of the case 15 are thus deactivated and the kinematic connection between pedestal and winch is carried out along the aforementioned first kinematic path.

When one wishes to reduce the transmission ratio for example so as to make a 1:1 ratio, the speed reducing means of the case 15 are activated by the crew members on boat board through actuation, for example, of the button/pedal 14b that drives the engage/disengage mechanism of the speed reduction case 15, which activates the aforementioned second kinematic path.

1. Motion transmission system for manoeuvring the ropes of sails in sailing boats, comprising at least one pedestal, at least one winch, kinematic connection means between said at least one pedestal and said at least one winch for the transmission of a rotary motion from said at least one pedestal to said at least one winch along at least one kinematic motion transmission path, and speed multiplier means active on said at least one kinematic motion transmission path to transfer the rotary motion from said at least one pedestal to said at least one winch with a first transmission ratio higher than 1:1, characterised in that said speed multiplier means are housed in said at least one pedestal.

2. Motion transmission system according to claim 1, wherein said pedestal comprises a drive pulley housed at a top end thereof, a driven pulley housed at a bottom end thereof and associated in output with said kinematic connection means, and a motion transmission belt between said drive pulley and said driven pulley, wherein said driven pulley has a diameter lower than the diameter of said drive pulley and wherein said speed multiplier means consist of said driven pulley.

3. Motion transmission system according to claim 2, wherein the diameter of said driven pulley is about half the diameter of said drive pulley.

4. Motion transmission system according to claim 1, wherein said kinematic connection means between said at least one pedestal and said at least one winch comprise speed reducing means able to be selectively activated on said at least one kinematic motion transmission path to transfer the rotary motion from said at least one pedestal to said at least one winch with a second transmission ratio lower than said first transmission ratio, said speed reducing means being housed in a case positioned at the input of said at least one winch.

5. Motion transmission system according to claim 4, wherein said second transmission ratio is 1:1.

6. Motion transmission system according to claim 4, wherein, when said speed reducing means are deactivated, the motion transmission from said at least one pedestal to said at least one winch takes place with said first transmission ratio, while when said speed reducing means are activated, the motion transmission from said at least one pedestal to said at least one winch takes place with said second transmission ratio.

7. Motion transmission system according to claim 4, wherein said speed reducing means comprise an input shaft rotating at an input speed and intended to be associated with said kinematic connection means between said at least one pedestal and said at least one winch, an output shaft rotating at an output speed and intended to be associated with said at least one winch, a first kinematic path for the motion transmission from said input shaft to said output shaft with said first transmission ratio, a second kinematic path for the motion transmission from said input shaft to said output shaft with said second transmission ratio, and means for selectively activating said first and second kinematic paths.

8. Pedestal for the motion transmission to at least one winch for manoeuvring the ropes in sailing boats, characterised in that it comprises speed multiplier means to transfer a rotary motion to at least one winch with a first transmission ratio higher than 1:1.

9. Pedestal according to claim 8, comprising a drive pulley housed at a top end thereof, a driven pulley housed at a bottom end thereof and intended to be associated in output with kinematic connection means between said pedestal and said at least one winch, and a motion transmission belt between said drive pulley and said driven pulley, wherein said driven pulley has a diameter lower than the diameter of said drive pulley and wherein said speed multiplier means consists of said driven pulley.

10. Pedestal according to claim 9, wherein the diameter of said driven pulley is about half the diameter of said drive pulley.
